(19) United States
(12) Patent Application Publication
(10) Pub. No.: US 2011/0258117 A1
(43) Pub. Date: Oct. 20, 2011

(54) MODIFICATION OF PAYMENT TRANSACTIONS IN REAL-TIME BASED UPON EXTERNAL DATA SOURCE

(75) Inventors: Farhan Ahmad, Chicago, IL (US); Meeri Siljamaki, Chicago, IL (US); Min Koo Lee, Lake Villa, IL (US); Chia-Lin Chen, Wilmette, IL (US)

(73) Assignee: DFS Services LLC, Riverwoods, IL (US)

(21) Appl. No.: 12/760,319

(22) Filed: Apr. 14, 2010

(51) Int. Cl. G06Q 20/00; G06F 17/30; G06Q 30/00

(52) U.S. Cl. 705/44; 707/769; 707/E17.014

(57) ABSTRACT

A system for, and method of using multiple data flows, both transactional and non-transactional, in real time to modify a transaction is disclosed. Further the use of transaction information in real time as a decision factor to trigger a different, non-transactional response, and the combination of the two approaches is disclosed. In particular, a network comprised of a plurality of software modules and databases is capable of combining current POS/POP transaction data, with a variety of other outside data sources to provide improved information for adjusting responses to transactions in real time. More specifically, the network utilizes payer facing systems to analyze the data in combination with well-known POS/POP transaction data and a variety of internal and external systems to combine information and provide modified transactions, related discounts and offers, and other relevant messaging to the payer. In addition, a specific method for analyzing for fraud within hybrid information transactions is disclosed and several examples to illustrate the invention are included.

### FIELD OF THE INVENTION

The present invention relates to the area of financial transaction processing, and more specifically relates to the use of multiple sources of data to modify real-time transaction decision making and behavior.

### BACKGROUND

Electronic transactions have become an everyday part of the economy. Whether the use occurs in person, or remotely, utilization of various electronic payment instruments (credit, debit, prepaid, ACH, alternative, etc) is huge and rapidly growing. Thus payers expect ever-improving benefits and services through use of their electronic payment instruments, and the entities involved (merchants, acquirers, network operators, issuers) all seek improved ways of growing their business in this area.

Currently the information collected and transmitted at point-of-sale (POS) or at point-of-purchase (POP) for financial transactions via electronic payment instruments are limited to a set amount and type of information. Changing the data stream collected at and transmitted from POS/POP purchases can be done; but it is cumbersome, must be agreed upon by stakeholders, and typically is expensive. What is needed is a system where information flow can be enhanced without requiring changes to the POS system.

Two further issues are that (1) the information currently available via a POS/POP transaction is not used to greatest benefit for the payer and other entities in the transaction ecosystem, and (2) additional information is available that can be obtained outside of the POS/POP transaction flow and used to benefit the payer and entities in the transaction ecosystem. What is needed is a better way of combining both available POS/POP transaction information and selective information outside of the POS/POP transaction for greater ecosystem benefit.

Finally, because the currently available data is not obtained, processed and acted upon, in real time, the nature of decisions made by the network operator (or other entities in the transaction ecosystem) is limited. Information, accessed instantaneously, would help to add both greater relevance and speed to decisioning and actioning, leading, for example, to uses such as improved fraud detection within transactions. What is needed is a way to support more specific, relevant, and improved data gathering, decision making and actioning in the transaction process in real time.

### BRIEF SUMMARY OF THE INVENTION

A system and method are provided for using multiple data flows, including sources external to a financial transaction network, in real time to modify a transaction, and to use transaction information in real time as a decision factor to trigger a different, non-transactional response. The data flows are extracted from current POS/POP transaction data content, in addition to outside data sources, accessible in real time for rapid assessment and decision making. This provides advantages over previous systems that were limited to using only information that was internal to entities on the transaction path, that could not modify transactions, or could not perform such actions without slowing the transaction process considerably.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 illustrates a functional block diagram of overall system 100 of using multiple data flows to modify transaction behavior in accordance with the invention.

FIG. 2 illustrates a functional block diagram of overall system 100, including further specifics of network operator 114, in accordance with the invention.

FIG. 3 illustrates a method 300 of utilizing hybrid information in financial transactions initiated by a transaction at POS/POP.

FIG. 4 illustrates an exemplary method 400 of utilizing hybrid information for fraud initiated by a transaction at Point of Purchase.

FIG. 5 illustrates an example of utilizing hybrid information for system-initiated cash back bonus & offer communications.

FIG. 6 illustrates an example of utilizing hybrid information for transaction-initiated offer communications.

### DETAILED DESCRIPTION OF THE INVENTION

Described below are a system for, and methods of using multiple data flows, both transactional and non-transactional, in real time to modify a transaction, or to use transaction information in real time as a decision factor to trigger a different, non-transactional response, or both. The data flows are extracted from current POS/POP transaction data content, in addition to outside data sources, accessible in real time for rapid assessment and decision making.

Therefore, the detailed description set forth below in connection with the appended figures is intended as a description of presently preferred embodiments of the method and system and is not intended to limit the use of the invention with any other embodiments. It is to be understood that the same or similar functions may be accomplished by different embodiments that could be included within different embodiments of the said method and system.

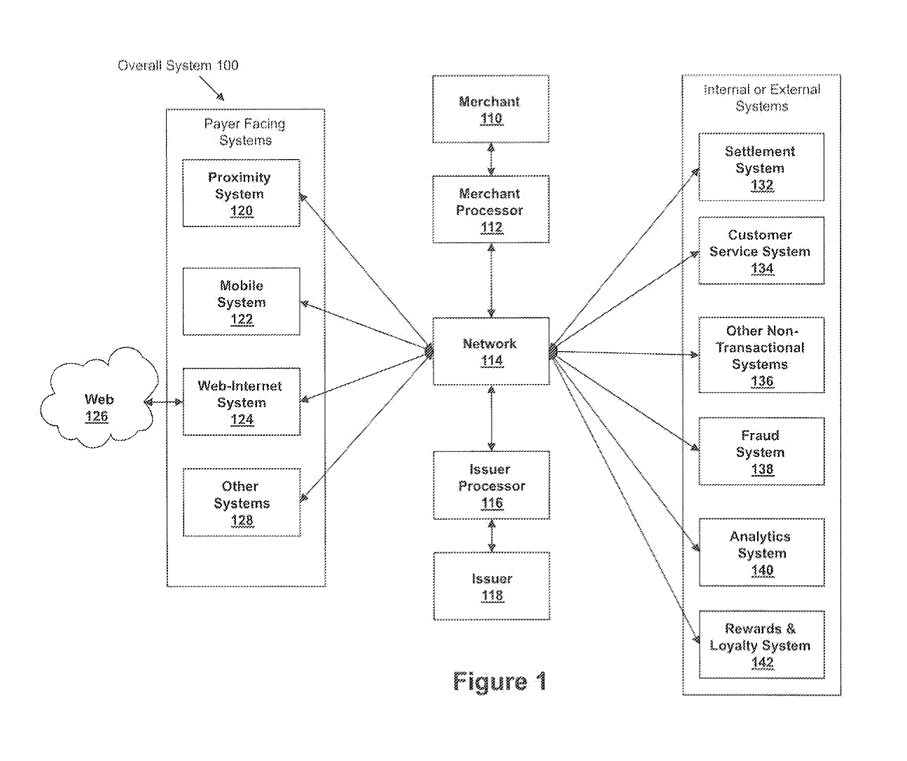

FIG. 1 illustrates a functional block diagram of overall system 100 of using multiple data flows to modify transaction behavior. Electronic transactions are a common method of effecting payment in connection with a transaction. In a typical transaction, a customer selects merchandise or services and presents a payment instrument to a merchant 110. Before merchant 110 releases the merchandise or performs the service, merchant 110 will typically get authorization or authentication in the amount agreed on for the merchandise or service, at the POS/POP. In this case, merchant is used as a general term meaning any party who takes payment for a good or service; for example a brick and mortar merchant, internet merchant, mail order merchant, a remote unmanned POS/POP terminal etc. As is well known to those skilled in the art, the parties in this transaction process can vary and can include a variety of combinations including but not limited to merchant processor 112, network operator 114, issuer processor 116, and issuer 118. The parties to the transaction are preferably electronically connected via an electronic financial transaction network that allows for electronic communications, requests and responses to flow between them securely. Merchant processor 112 is any party who provides transaction and/or data processing services and routes an authorization request from merchant 110 to issuer processor 116 via network operator 114.

Issuer processor 116 is any party who provides transaction and/or data processing services on behalf of an issuer 118, Issuer processor 116 is connected with issuer 118, one of whom finally approves or denies the transaction and returns this information back to the network operator 114 who returns it to the merchant 110 or merchant processor 112. The information may or may not follow the exact data path of the transaction, but typically flows in the reverse order that the authorization request traveled. Issuer 118 is any party (financial institution, bank, credit union, or company) that issues, or causes to be issued, payment vehicles such as credit, debit or prepaid cards for example, to cardholders.

Network operator 114 interfaces with numerous other systems. Further illustrated in FIG. 1 are a set of “payer-facing systems” and other “internal and external systems” to network operator 114. All payer facing systems may be provided by the network operator or may be entirely remote from the network operator and provided by a third party. Payer-facing systems include proximity system 120, mobile system 122, web-internet system 124, and other systems 128.

Proximity system 120 is an apparatus comprised of both a global positioning system (GPS) device (or any other device) capable of providing information related to the physical location of a customer, and the requisite software and hardware capable of storing and transmitting that information to another location, such as network operator 114. Mobile system 122 is any type of mobile communication device belonging to a payer that is capable of one or two-way communication, which may include software applications, voice, email, and text messaging (e.g. short message service (SMS)), with network operator 114. Examples of mobile system 122 include but are not limited to a mobile telephone, a personal digital assistant (PDA), or a Smartphone. Note that the functions of proximity system 120 and mobile system 122 can be contained in a single device.

Web-internet system 124 is an interface such as a computer with a graphical user interface where a cardholder can provide information to network operator and receive information back 114. Web-internet system 124 is required to be connected either wired or wirelessly to web 126 in order to provide one or two-way communication via the internet or the World Wide Web services. As an example, a user may access a website hosted by network operator 114, where the user can receive or send account-related information, to and from network operator 114.

Other systems 128 is in one- or two-way communication with network operator 114 and is any system that provides data to network operator 114 in real time to support a transaction. For example, it could provide information on the location of a cardholder based on mass transit usage and provide that data to network operator 114 to be utilized in modifying a transaction or non-transactional trigger in some form.

Network operator 114 is in further two-way communication in real time with a multiple of internal or external systems, comprising but not limited to settlement system 132, customer service system 134, other non-transactional systems 136, fraud system 138, analytics system 140, and rewards & loyalty system 142, as shown in FIG. 1. These systems can be a part of network operator 114, but can also be remotely accessed and/or third party supplied.

Settlement system 132 is an internal system typical of transaction processing systems that settles and moves funds pertinent to the transaction in question. In the present invention, settlement system 132 communicates in real time to the authorization system information needed to incorporate non-transactional information data to modify a transaction, and thus change the price based on the characteristics of the non-transactional data.

Customer service system 134 is typically external to network operator 114 and capable of providing real time data feeds into the transaction process. Information stored in customer service system 134 or real time information such as call identification can be queried in real time and can provide, through customer service system 134, value-added information to the transaction. As an example, a payer may be unhappy with some aspect of the service they have been receiving, and has been recorded in the respective customer service database. Based on this information, when a transaction is made by this specific payer, information provided by the customer service system 134 could allow network operator 114 to react to this payer with a discount or some other type of promotion aimed to improve the relationship with this payer. Customer service system 134 can include a variety of non-transactional information, such as payer call velocity that can be utilized to make a more specific and relevant decision with regard to improving the customer service associated with a particular payer.

Other non-transactional systems 136 could be used as per the requirement of the overall system 100 and could include the utilization of a variety of information types from a variety of sources. As a first example, an external non-transactional system 136 holds information on payers such that account numbers are not required. This information could be in the form of pre-selected alphanumeric codes, social security numbers, cell phone numbers, or a unique network identifier, etc. This specific type of non-transactional system 136 is instrumental in instances where card instruments are not used in lieu of other payment vehicles such as biometrics, cell phone, etc.

As a second example, other non-transactional systems 136 could be weather information and used in combination with proximity system information 120 and analytics system information 140, the network operator 114 could provide a discount or rebate to the customer based on the weather in their location. Additional examples of information accessed via non-transactional systems 136 include stock market information, geography of the merchant, proximity of other merchants to POS/POP of the transaction, etc. Under the present invention, any procured or publicly available database that could influence a transaction in real time could be utilized as non-transactional systems 136 and combined in real time with transactional information.

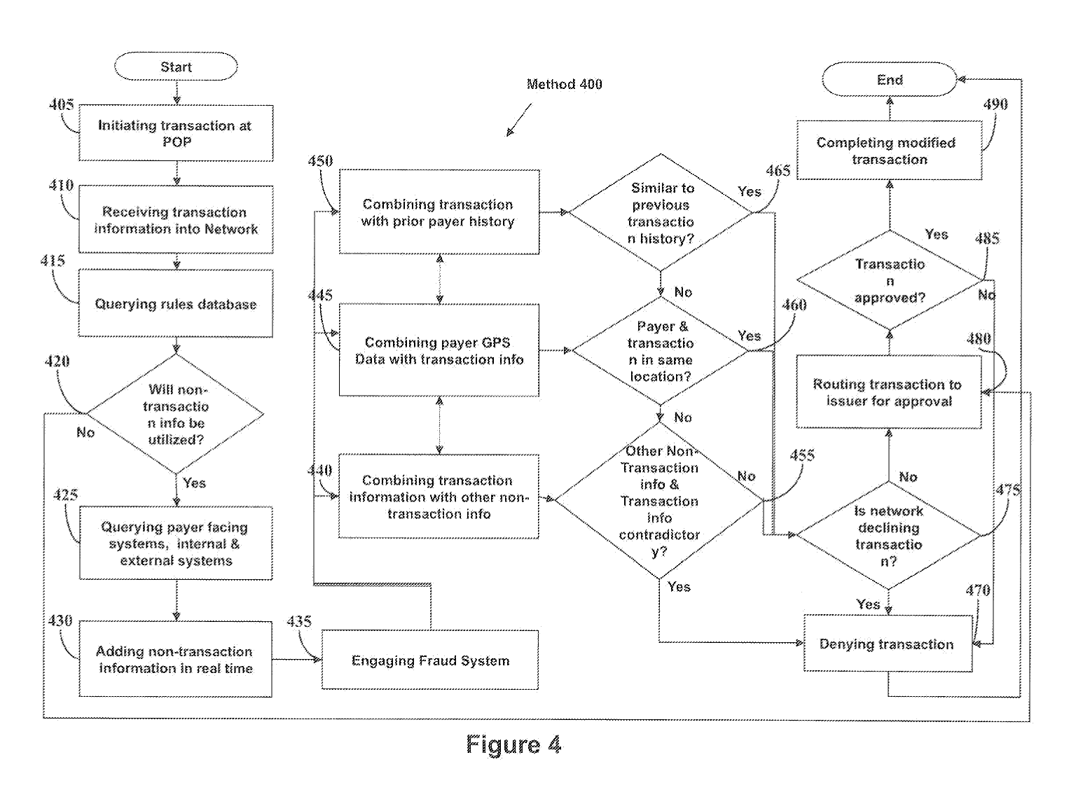

Fraud system 138 is generally an internal system within network operator 114. A real time response is triggered based on analysis of information by fraud system 138 with regards to a specific payer's transaction for potential fraud. If, during a transaction, the data is analyzed within network operator 114 and there is a contradiction between different available sets of information, the fraud system 138 assesses the information and generates some form of a fraud message and routes it back to merchant 110, issuer 118, issuer processor 116 or payer along with the transactional information or it dictates that the transaction flow or message must be altered in some way. In addition, the fraud system 138 provides information on lost, stolen, or otherwise compromised accounts in order to inform network operator 114. For example, fraud system 138 could interact with proximity system 120 or mobile system 122 to determine the physical location of cardholder to ensure that a cardholder and a transaction at a specific merchant are taking place at the same physical location. Depending on the physical arrangement of overall system 100, functions of fraud system 138 and network operator 114 can easily be split with no loss of functionality, such that analysis takes place in one segment and decision and action takes place in another. Further detail on the operations specifically to assess and relay fraud-related activity is provided in method 400, and in FIG. 4 below.

Analytics system 140 is an analytical system in two-way communication with network operator 114. Analytics system 140 acts on real time data coming in and combines it with data regarding purchasing patterns and habits, which may be both specific to the payer behavior, or may also be based on marketing research, demographics information, etc. Analytics system 140 traditionally delivers offers in non-real time; however in an embodiment, analytics system 140 is queried, updated and responds in real time in order to provide instantaneous transaction information.

Rewards & loyalty system 142 is typically a third party system to manage rewards or loyalty programs. Rewards & loyalty system 142 decisions, for example, on data regarding current member status, points accumulated, and other loyalty-based incentive programs to provide benefits to the payer on the basis of using a specific payment type, belonging to a specific type of rewards program, or membership in any relevant reward or loyalty type program. Reward & loyalty system 142 can provide any type of a reward and/or benefit based on a specific payer's behavior. Rewards & loyalty system 142 traditionally delivers information in non-real time; however under the present invention, rewards & loyalty system 142 is queried, updated and responds in real time in order to provide instantaneous information.

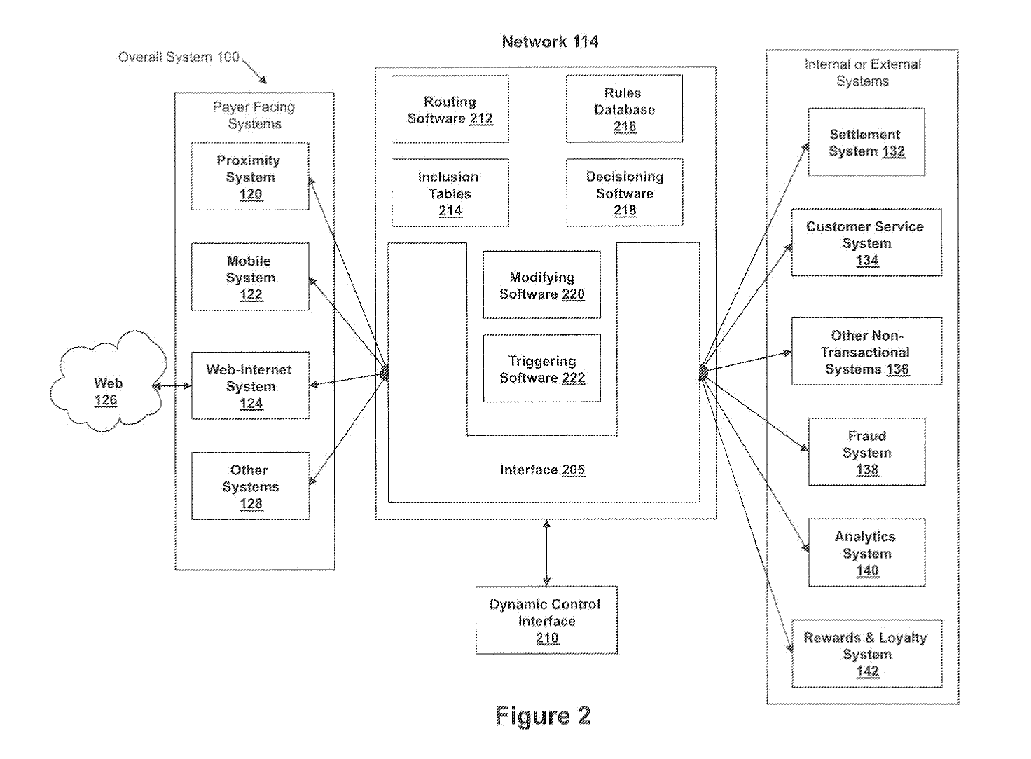

FIG. 2 illustrates in greater detail the subcomponents of network operator 114, which support control and decision making within system 100 according to the present invention. Network operator 114 is capable of interacting in one-way and two-way communication with a variety of systems and interfaces, as described below. In a preferred embodiment, network operator 114 includes interface 205, dynamic control interface 210, routing software 212, a set of inclusion tables 214, a rules database 216, decisioning software 218, modifying software 220, and triggering software 222. Network operator 114 and its subcomponents are located between merchant 110 and issuer 118, so that transactions flow through it. Network operator 114 and its subcomponents are preferably designed such that the communications and queries described below are performed in substantially real-time during the course of a transaction. In this manner, the authorization and transaction process is not slowed down or otherwise adversely affected from the perspective of the payer or merchant.

Interface 205 is a device, program, peripheral, or graphical user interface (GUI) that permits wired or wireless connection to an external network or system in one or two way communication. In tone embodiment, interface 205 is required for network operator 114 to interact with other networks and sources of data for transaction processing. For example, transaction data is typically received by network operator 114 from merchant 110 via a variety of connections. The transaction data is routed through network operator 114 to the next step in transaction authorization (e.g., issuer 118 or issuer processor 116). In the present invention, interface 120 also receives and transmits information related to non-transaction or “hybrid” data to assist in real time data flow.

Dynamic control interface 210 consists of both hardware and software that provides network customer (merchant, processor, issuer) and/or payer interactivity with network operator 114 in real time, which is not currently supported in prior art systems. Typically payers can only interact in tightly managed, “binary” type decisions regarding card preferences. For example, payers may currently utilize web-internet system 124 via web 126 to access account information. However these changes are typically limited in scope (only certain card features can be managed in this manner) and not dynamic in nature—they cannot be changed constantly depending on payer circumstances and needs. In one embodiment, dynamic control interface 210 assists and manages the real time flow of data from the network customer or payer through to network operator 114 in real time.

As an example, a small business owner uses the dynamic control interface 210 to set limits on allowed use on cards given for employees to make payments. The business owner can set a specific dollar amount limit for payments, within a specific timeframe, at a specific merchant 110 location, such that a contractor could make a pickup and pay for materials without concern as to fraudulent or unauthorized use of the card by the employee or any other party.

Routing software 212 is a software program that traditionally uses the BIN number of the transaction to direct the information to the appropriate issuer processor 116 or issuer 118. In one embodiment, routing software 212 has enhanced functionality to route the transaction based on information not typically or traditionally used in a real-time manner for transactions. This information may include any field currently in an authorization message plus additional non-transactional information, for example, a payer could stipulate rules via the dynamic control interface 210 that all payment transactions above a certain dollar amount should route to one type of payment account such as a credit card account and other transactions below a certain dollar amount would route to a different payment account—for instance a bank account via ACH. Then, routing software 212 handles how the transaction is to be routed based on payer preference and would enable a single payment device at the POS/POP for multiple payment methods. Routing software 212 includes software instructions on the order of data flow through network operator 114, and provides the “orchestration” of combining transaction and non-transaction data within network operator 114.

Based on either pre-programmed queries that dictate specific interfaces to be considered, or conditional queries based upon the content of the transaction (or both), routing software 212 sends an inquiry regarding the transaction data to the appropriate interface. Routing software 212 manages incoming data from transactions, adds to it relevant data from other sources, and sends the data out to the next entity in the authorization path (such as issuer processor 116).

Inclusion tables 214 is a data structure typically used to apply static basic rules for filtering and thus approving or denying a transaction. Inclusion tables can be a part of network operator 114 or can be 3^{rd} party supplied. In specific situations, network operator 114 may be authorized to make this decision for a given transaction. This decision would typically be made based on factors that include but are not limited to whether card can be used at a particular merchant 110 etc. In one embodiment, inclusion tables 214 are dynamically updated by real time information and can include that information in an assessment of the transaction.

Inclusion tables 214 provide information to network operator 114 to make an informed decision about which of the available resources may be utilized for that particular transaction. For example, inclusion tables 214 may include lists of accounts that are participants in a rewards & loyalty program, or lists of accounts that have a customer service system profile available to be accessed.

Rules database 216 is a repository for logic around conditions to allow or disallow changes to transactions or triggering events. Multiple sets of rules may reside in rules database 216 based on transaction characteristics or information available through inclusion tables 214, and can be used to make “if-then” decisions regarding the transaction. In one example, rules database 216 contains information on conditions that trigger a fraud analysis of the transaction. In another example, rules database 216 contains information on what types of transactions might trigger a response or event such as an offer from the system. Rules database 216 is designed to be easily modified and updated by network operator 114, or alternatively merchant 110, merchant processor 112, issuer processor 116, issuer 188 or payers when new sets of rules are developed. Any guidance regarding possible modifications to the transaction that require thresholds, behavioral triggers, or conditions to be met are contained within rules database 216.

Decisioning software 218 is a dynamic software program that utilizes the information available from all other systems, interfaces and transactions in order to determine which external or internal systems, payer facing systems and/or network systems will be queried and utilized in the transaction for possible modification. It is possible that no systems or data sources will be queried. In that event, no modifications are made or triggers released, and the transaction data is transmitted via issuer processor 116 to issuer 118 without additional information via routing software 212 and interface 205 to be authorized. If decisioning software 218 determines there are in fact one or more systems to be accessed, an external query is made via interface 205 and the response is received and directed to modifying software 220 or triggering software 222 for appropriate action.

Modifying software 220 is a software program that modifies the transaction information on the basis of available transactional or non-transactional information. Modifying software 220 requires capabilities to receive and act on all types of information available via the variety of systems and interfaces with network operator 114. Modifying software 220 stores information on all allowable modifications to transactions, and initiates them based on information received from decisioning software 218. For example, if decisioning software 218 determines that rewards and loyalty system 142 should be queried based on inclusion tables 214, and the information received from rewards and loyalty system 142 shows that a payer is eligible for a specific reward, and a discount should be applied to a specific transaction, modifying software 220 can modify the transaction so that a discount is applied in real time to the transaction and sent back to merchant 110 and/or the payer in real time.

Note that the design and operation of modifying software 220 can be relatively simple, or more complex based on the number of real-time inputs and data to be analyzed. Modifying software 220 is capable of modifying the transaction before, during, or after a transaction is transmitted to issuer processor 116 and issuer 118 for authorization. The choice of when the transaction is modified depends on the type of transaction modifications to be executed, which interfaces need to be consulted, and whether issuer 118 should be involved with those modifications or not.

As an example, a possible instance of fraud, determined via analysis of the transaction characteristics, may be immediately filtered by inclusion tables 114, or the information may be sent by decisioning software 218 out to fraud system 138, or may wait upon issuer 118 to accept or deny the transaction. In each case, modifying software 220 is designed to be triggered upon different data “cues” received by network operator 114.

Triggering software 222 is software that is used to generate actions based on different data “cues” received by Network operator 114 to be conducted by Network operator 114, Payer Facing Systems and/or Internal or External Systems. A process to modify a transaction may start by the Decisioning Software 218 communicating to Triggering Software 222 that a certain action needs to be triggered. Triggering Software will then communicate to the Modifying Software 220 to modify the transaction in question. This may happen in a sequential form or parallel depending on the situation and desired outcome. As another example the Triggering Software 222 can trigger message to be sent to the payer by the Mobile System 122 based on payer proximity tracking (e.g. through GPS data results). In an example where a payer has “opted in” to proximity tracking, Triggering Software 222 receives input from Inclusion Tables 214, Rules Database 216, and Decisioning Software 218 that directs Triggering Software 222 to initiate a message to a payer. The message, which may be sent via phone, email, SMS or other messaging protocol, may relay an offer, discount, current balance, or other important information to them based on their proximity to a merchant. Note that the function of Triggering Software 222 in this example does not rely on a purchase to be made since it results from proximity detection. However, the Triggering Software can initiate actions based on any and all information received by Network operator 114, which in many cases includes transaction information among other data.

It is further noted that each of routing software 212, decisioning software 218, and modifying software 220 function according to their specific code and programming design. These software modules can divide and share filtering aspects of the system, as determined best by the architect of the source code.

In addition, the information is shared seamlessly and confidentially within the modules in network operator 114 between network operator 114, Payer Facing Systems and Internal or External Systems. For example, no transmission of data outside of these systems is required to access payer account information, and that information flows directly through assessment of merchant offers via rules database 216 and filtering/decisioning via decisioning software 218 and modifying software 220. It is understood that the computer code required to execute any and all of these scenarios is well understood in the art and within the scope of the present invention.

In operation, typically merchant 110 sends an authorization request with transaction information to issuer 118 through merchant processor 112, network operator 114, and issuer processor 116. Before network operator 114 routes the transaction to issuer processor 116 (or issuer 118) it accesses and analyzes any non-transactional information through any or all of the available systems & interfaces and combines it with the transaction information. Based on the nature of the transaction, the transaction information enters network operator 114 through interface 205 and via real-time control and assistance of routing software 212, is combined, routed, and potentially modified utilizing all or any of inclusion tables 214, rules database 216, decisioning software 218, and modifying software 220.

Routing software 212 routes the transaction information to inclusion tables 214 to determine which programs, discounts, etc. may be applicable for modification. Next, the transaction is assessed using rules database 216 in conjunction with decisioning database 218, to determine which (if any) systems and interfaces are to be queried for additional non-transaction information. If additional information is obtained via queries to either internal or external systems, appropriate changes are made via modifying software 220 (or as described above, may be modified immediately and not require information back from outside interfaces, or may also wait in a data queue for incoming information from not only outside interfaces but additionally from issuer 118). The resulting “hybrid” transaction (based on both transaction and non-transaction information) is transmitted in coordination of routing software 212 via interface 205 to issuer processor 116 or directly to issuer 118. Depending on the nature of the transaction, and as is well known, the approval/denial decision made by issuer 118 is sent back to merchant 110 via issuer processor 116, network operator 114, and merchant processor 112.

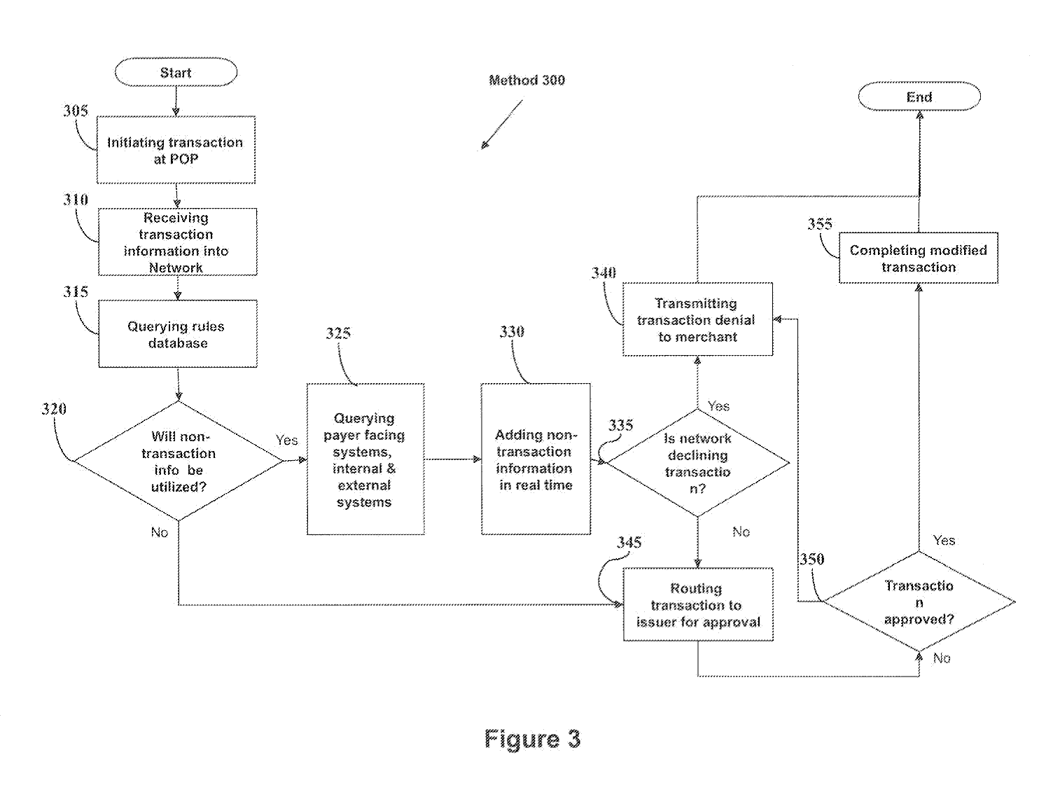

FIG. 3 illustrates a method 300 of utilizing hybrid information in financial transactions initiated by a transaction at POS/POP, according to one embodiment. The illustrated method begins by initiating transaction at POS/POP at step 305. In this step, a payer who has selected merchandise or services presents a payment vehicle, such as for example, a card (credit, debit, prepaid, check), cell phone, biometrics etc. to a merchant 110. Before merchant 110 releases the merchandise or performs the service, merchant 110 will initiate and receive authorization for a charge in the amount agreed upon for the merchandise or service, at the POS/POP. For example, merchant 110 captures the payer's information via the magnetic stripe on a card instrument by swiping the card through a terminal, or by entering the card data and payment information into a computer and sends the transaction information for authorization. Note that depending upon the specific payment vehicle used, a card account number may not be required, particularly in a situation where a payment vehicle other than a traditional card is used to pay for the purchase. In this case a combination of identifying information, such as a pre-set alphanumeric code, social security number, cell phone number, email address etc. are used in combination to identify the payer. Method 300 proceeds to step 310.

At step 310, the transaction information and authorization request is sent to, and received by network operator 114 via interface 205, over the electronic financial transaction network. Within network operator 114, the transaction data is initially handled by routing software 212 and directed within network operator 114. Method 300 proceeds to step 315.

At step 315, routing software 212 queries the multiple sets of rules in rules database 216 to make decisions regarding the transaction, including guidance regarding possible modifications to the transaction that require thresholds, behavioral triggers, or conditions to be met. The result of this query is used in the following step to determine what, if any, modifications can be made to the transaction. Method 300 proceeds to step 320.

At step 320, the transaction information is routed, via appropriate selections of routing software 212, through inclusion tables 214, rules database 216, and decisioning software 218. In some cases these elements will all be needed, and in other cases only one or two of them are required to assess and execute a modified transaction.

For example, inclusion tables 214 may be sufficient to determine that a payer is qualified for a program delivering an “instant discount”. However in the case where a transaction is selectively routed to either a card account or an ACH bank account, the processing may involve both hybrid routing and hybrid message modification.

Per the functions described in FIG. 2 above, a determination of both whether non-transaction information will be utilized, and which payer facing systems and internal or external systems need to be queried, is made by decisioning software 218. If there is any non-transaction information that needs to be utilized, method 300 proceeds to step 325; otherwise method 300 proceeds to step 345, where the transaction data is sent to issuer processor 116 and/or issuer 118 for approval per traditional authorization processes.

In the event there is non-transaction information to be utilized, then at step 325 any of the available systems, including but not limited to proximity system 120, mobile system 122, web-internet system 124, other systems 128, settlement system 132, customer service system 134, other non-transactional systems 136, fraud system 138, analytics system 140, and rewards & system loyalty system 142 are queried for potentially applicable information to be utilized in the transaction. Information is transmitted from these respective external systems back to network operator 114 via interface 205, where the non-transactional data is handled. Method 300 proceeds to step 330.

At step 330, information provided from payer facing systems and internal and external systems is utilized by modifying software 220, in conjunction with current transaction information, to determine what the resultant change or add is to be made to the transaction in real time. Note that the information flow of transaction and non-transaction information is enhanced without requiring changes to the POS/POP process itself.

Depending upon the specific type of modification to be made, modifying software 220 will either add to or change the transaction message before, during or after being sent to issuer for approval. As an example, issuer 118 needs information on fraud detection to be transmitted, but does not need information on merchant-driven programs for rewards and discounts. Separately from the transaction approval itself, non-transactional information provided via internal or external interfaces may also trigger a message, contact, or other messaging transmitted to the payer. These messages may be in the form of email, SMS, phone call, or physical offers that are related to the payer profile or the specific purchase being made.

Note that merchant 110 or issuer 118 can structure specific offers, which are included in inclusion tables 214 and rules database 216, to provide payers with incentives to purchase specific items, at selected merchants, within specific time periods or any combination of parameters to encourage differentiated and increased sales, or example during non-peak purchasing periods. Method 300 proceeds to step 335.

At step 335, the transaction information is assessed via use of inclusion tables 214 for network approval or denial of the transaction, in specific cases (e.g. network operator 114 is not connected to issuer 118 for electronic approval). If network operator 114 is authorized to decline the transaction, and the available non-transaction information indicates it should be declined, method 300 proceeds to step 340. If network operator 114 is authorized to approve the transaction, and the transaction is approved at this point, method 300 proceeds to step 345.

At step 340, network operator 114, via interface 105, transmits a message to merchant 110 denying the transaction (which may be a hard or soft denial depending upon the specific characteristics of the transaction). Method 300 ends.

At step 345, the transaction is routed through issuer processor 116 to issuer 118, or to issuer 118 directly, for approval. The modified transaction information is held within network operator 114, preferably by modifying software 212, pending a decision on transaction approval by issuer 118. For example, if issuer 118 denies the transaction, the modification based on the non-transactional information will not be made. This step occurs regardless of whether the transaction message contains modified information or not. Method 300 proceeds to step 350.

At step 350 issuer 118 either approves or declines the transaction, as is well known in the art. If approved, method 300 proceeds to step 355. If declined, method 300 proceeds to step 340.

At step 355 the modified transaction information that was held within network operator 114 pending approval, is executed. The transaction is routed to the merchant and to the settlement system 132 for normal processing; however, any modifications to the transaction using the combined sources of information available to network operator 114 are simultaneously executed.

For example, a discount could be provided to the payer in real time for their purchase, or a related offer could be dispatched via text message based on their physical proximity to another retailer. Note that the transaction amount is in fact changed in the case where a real time discount is applied; thus resulting in the transaction amount initially transmitted from the POS/POP being different from that which returns for amount of purchase (which is less by some percentage or flat amount). Method 300 ends.

Method 300, using overall system 100, provides a way to utilize both available POS/POP transaction information and selective non-transaction information to distinctly change network response and behavior in the transaction process in real time for greater benefit for all parties, and is not currently available in the traditional POS/POP process.

Further, embodiments support more specific, relevant, improved decision making in the transaction process, through use of real-time data as demonstrated by the inclusion of information from outside data sources.

FIG. 4 illustrates method 400 of analyzing for fraud within hybrid information financial transactions. Method 400 is one specific example of the process flow that may occur within method 300, wherein fraud system 138 is utilized. In this example, method 400 refers to system 100 as illustrated in FIG. 1 and FIG. 2; however, method 400 may operate using variations of system 100 not shown in the current system. Method 400, in accordance with one embodiment, is illustrated in FIG. 4.

At step 405, a payer who has selected merchandise or services presents a card (such as a credit card, check card or debit card) or other cardless form of identification and payment (such as biometrics, payment via cell phone, etc.) to a merchant 110. Before merchant 110 releases the merchandise or performs the service, merchant 110 will initiate and receive authorization for a charge in the amount agreed upon for the merchandise or service, at the POS/POP.

For example, merchant 110 captures the payer's card information via the magnetic strip on a card, contactless chip, EMV, phone or other device used as a payment vehicle or by entering the card data and payment information into a computer and sends the transaction information for authorization. Method 400 proceeds to step 410.

In this step, the transaction information and authorization request is sent to, and received by network operator 114 via interface 205. Within network operator 114, the transaction data is initially handled by routing software 212 and directed within network operator 114. Method 400 proceeds to step 415.

At step 415, routing software 212 queries the multiple sets of rules in rules database 216 to make decisions regarding the transaction, including guidance regarding possible modifications to the transaction that require thresholds, behavioral triggers, or conditions to be met. Note that in this specific example of fraud detection, inclusion tables 214 will likely change dynamically over time (i.e. account numbers known to be stolen or in default will change). The result of this query is used in the following step to determine what, if any, modifications can be made to the transaction. Method 400 proceeds to step 420 to determine if non-transaction information will be utilized.

In this step 420, the transaction information is routed, via routing software 212, through inclusion tables 214, rules database 216, and decisioning software 218. Per the functions described in FIG. 2 above, a determination of both whether non-transaction information will be utilized, and which external interfaces need to be queried, is made by decisioning software 218. If there is any non-transaction information that can be utilized, method 400 proceeds to step 425; otherwise method 400 proceeds to step 480, where the transaction data is sent to issuer processor 116 and/or issuer 118 for approval per traditional authentication processes.

At step 425, any of the available interfaces, including but not limited to proximity system 120, mobile system 122, web-internet system 124, other systems 128, settlement system 132, customer service system 134, other non-transactional systems 136, fraud system 138, analytics system 140, and rewards & system loyalty system 142 are queried by decisioning software 218 for potentially applicable information to be utilized in the transaction. Information is transmitted from these respective external systems back to network operator 114 via interface 205, where the non-transactional data is handled by routing software 212. Method 400 proceeds to step 430.

At step 430, information provided from external interfaces is utilized by modifying software 220, in conjunction with current transaction information, to determine what the resultant change or add is to be made to the transaction in real time. In this specific example, modifying software 220 waits to execute the modification based on fraud detection information to be transmitted. Method 400 proceeds to step 435, where fraud system 138 is engaged to analyze the transaction by either routing software 212 or decisioning software 218. Steps 420 through 435 detail an example of a typical decisioning process when network operator 114 engages fraud system 138 to evaluate a particular transaction for fraud. Method 400 proceeds to step 440.

In an embodiment, steps 440, 445, and 450 essentially all occur simultaneously in parallel—they are three data inquiries and comparisons made to determine the likelihood of fraud in the transaction. Note that these three steps have been selected as likely triggers to help identify possible fraud; however there may be others in addition to, or as a replacement for these three steps that could be considered in the invention.

At step 440, any of the available interfaces, including but not limited to proximity system 120, mobile system 122, web-internet system 124, other systems 128, settlement system 132, customer service system 134, other non-transactional systems 136, fraud system 138, analytics system 140, and rewards & system loyalty system 142 are queried by decisioning software 218 for potentially applicable information to be utilized in the transaction. Information is transmitted from these respective systems back to network operator 114 via interface 205, where the non-transactional data is handled by routing software 212. Method 400 proceeds to step 455, while steps 445 and 450 occur in parallel.

At step 445, network operator 114 determines the location of the payer via use of proximity system 120. Note that as previously described, proximity system 120 preferably contains both a global positioning system (GPS) device (or any other device) capable of providing information related to the physical location of a customer, and the capability to store and transmit that information to another location, such as network operator 114. Network operator 114 utilizes the payer identification, in conjunction with knowledge of the payer cell phone number, to inquire via interface 205 to proximity system 120 and determine the real-time location of the payer's GPS device, whether contained in a mobile system 122 or not. Method 400 proceeds to step 460, while step 450 occurs in parallel.

At step 450, network operator 114 combines the current transaction with the payer's prior history. This history may be provided by inquiries to databases such as customer service system 134, analytics system 140, rewards & loyalty system 142, or any other available internal or external systems that provide information on the payer's buying habits. Method 400 proceeds to step 465.

At step 455, fraud system 138 analyzes the payer's previous purchases and ensures that the current transaction is similar or in line with prior transactions or purchases that have been made in the past. For example, the transaction history may indicate that payer had not made a transaction of more than $100 in past five years. However, the current transaction is for $5000. In this example, fraud system 138 would determine that the current transaction is not in-line with previous purchases made by the payer. If the current transaction is similar to previous transaction history, method 400 proceeds to step 475; if not, method 400 proceeds to step 460.

At step 460, fraud system 138 analyzes the location of the payer via proximity system 120 and the location of merchant 110 to determine if they are in the same physical space. For example, the merchant 110 where the transaction is taking place is located in Ohio and but proximity system 120 determines the payer is in California; this might indicate a case of potential fraud. If the payer and the merchant are in the same location, method 400 proceeds to step 475. If not, method 400 proceeds to step 465.

At step 465, fraud system 138 matches transaction information with non-transaction information on any number of possible variables. For example, a payer may have requested that transactions on their card will not be authorized for the next 2 months while they travel abroad. The week following this request, or immediately thereafter, an authorization request is received. Fraud system 138 analyses the transaction information with non-transaction information received and determines that this might indicate a case of potential fraud. If the non-transaction information is contradictory to transaction information, method 400 proceeds to step 470. If the information is not contradictory, method 400 proceeds to step 475.

At step 470, fraud system 138 transmits a potential fraud alert message to network operator 114. For example, if the transaction information and the non-transaction information are found to be contradictory, network operator 114 may generate a hard decline, a soft decline, or request that merchant 110 request additional information from the payer (as is well known to those skilled in the art). Method 400 ends.

At step 475, network operator 114 determines whether the transaction should be approved, based on the nature of the specific transaction, the non-transaction information, and the authority of network operator 114. If network operator 114 is authorized to decline the transaction, and the available fraud information indicates it should be declined, method 400 proceeds to Step 470. If network operator 114 is authorized to approve the transaction, and the transaction is approved at this point, method 400 proceeds to Step 480.

At step 480, transaction is routed through issuer processor 116 to issuer 118, or to issuer 118 directly, for approval. The modified transaction information is held within network operator 114, preferably by modifying software 212, pending a decision on transaction approval by issuer 118. For example, if issuer 118 denies the transaction, the modification based on the non-transactional information will not be made. This step occurs regardless of whether the transaction message contains modified information or not. Method 400 proceeds to step 485.

At step 485, issuer 118 either approves or declines the transaction, as is well known in the art. If approved, method 400 proceeds to step 490. If declined, method 400 proceeds to step 470.

At step 490, both the transaction authorization and the results of the modified transaction are transmitted from network operator 114 via merchant processor 112 to merchant 110. This may include any type of alert or warning which may be transmitted by network operator 114 to the payer (such as via mobile system 122) or directly to the POS/POP at merchant 110. The transaction is routed to settlement system 132 for normal processing; however, any modifications to the transaction using the combined sources of information available to network operator 114 are simultaneously executed. Method 400 ends.

Method 400 provides a specific example using overall system 100 to utilize both available POS/POP transaction information and selective non-transaction information to provide better real-time fraud identification and action, which is not currently available in the traditional POS/POP process.

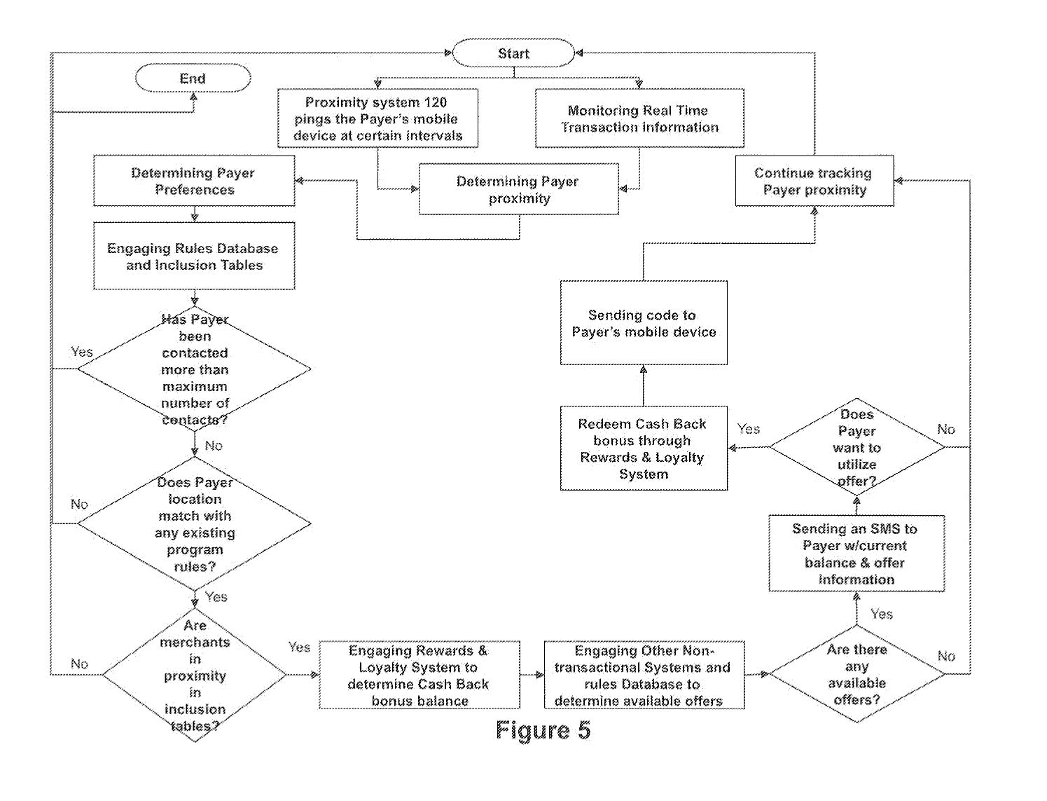

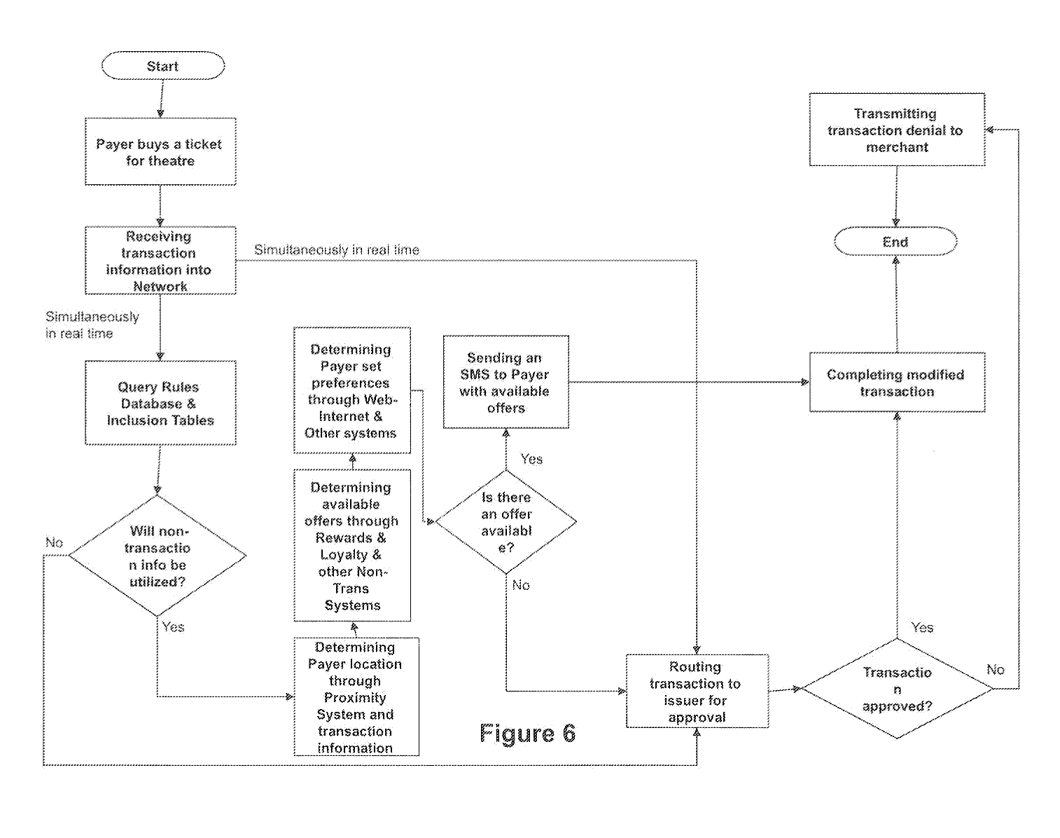

Specific examples of the present invention are provided as alternate embodiments. In FIG. 5 and FIG. 6, two different examples are illustrated and are described below.

FIG. 5 illustrates a method of utilizing hybrid information for system-initiated rewards & offer communications, in accordance with an embodiment. In this example, the process begins with two steps in parallel. First, the network operator periodically “pings” a payer mobile device at regular intervals to determine the payer location. Second, the network operator also monitors payer transactions in real time. Either one or both types of information is used to determine the payer location.

The next set of steps can all be processed in rapid sequence or simultaneously. Payer preferences are determined to ensure that this particular customer does want to be contacted by the network operator with offers, and how they prefer to be contacted. Using the rules database and inclusion tables contained in the network operator, appropriate programs, offers, and limitations are determined through three data queries described below.

The next decision steps determine whether the process will continue forward, or loop back to the start for tracking the payer proximity. First the network operator determines whether a pre-set threshold of offers has been exceeded already. If not, the process continues. Then the network operator determines whether the payer location matches any of the program or offer rules that were scanned via the rules database and inclusion table. If there are some viable programs, the process continues. Finally the network operator determines whether the proximate merchants are in the inclusion tables. If there are some qualifying merchants, the process continues. Otherwise, the process returns back to the “monitoring” mode to track the payer proximity.

The next step is to engage the rewards and loyalty system to determine the payer's current rewards balance, followed by determining available offers by combining information from both the rules database and inclusion tables with other non-transactional, and possibly external systems.

If there are in fact available offers within the boundaries and limitations of the prior steps, triggering software initiates an SMS message with their current balance, and offer information to be sent to the payer's mobile device by the mobile system. Note that triggering software in an embodiment need not rely on a purchase to be made since it results from payer proximity tracking. If proximity is determined by monitoring transaction activity (e.g., from merchant information sent as part of an authorization request for a transaction), then the offer information is preferably not sent to the payer's mobile device until it has been determined that the authorization request has been approved. In this manner, offers are not sent when transactions are not approved. If there are no offers available, the process returns to the “monitoring” mode to track the payer proximity.

After receiving the SMS, the payer determines whether they want to utilize the offer. If not, again the process returns to the “monitoring” mode. If they elect to use the offer, the payer will accept the offer by, for example, pressing “accept” on their phone or by sending a return SMS to the network operator. The offer is redeemed as a cash back bonus through rewards and loyalty system, and a code is sent to the payer's mobile device, which the payer can use to pay for the purchase. The system returns to the “monitoring” mode to track payer proximity.

The offering process described with respect to FIG. 5 can also be used for “counter-based” offers, in accordance with an embodiment. In such an arrangement, the network operator 114 maintains a database on behalf of a number of merchants for tracking frequency with which payers transact with those merchants. Such a database may be included within other systems previously described, such as the rewards and loyalty system 142, or may be separate. A payer's record in the database is updated each time the payer transacts business with the corresponding merchant. When the payer begins a transaction and the authorization request is sent from the terminal device at the merchant, the database is checked to determine whether a threshold has been met. The threshold can take any of several forms, such as a total dollar amount, a number of times transactions have occurred (e.g., a “counter”), average values of these amounts over a desired time period (e.g., 3 times in one month), or similar threshold. If the threshold has been met, an offer is generated and sent to the payer over a secondary channel, such as by SMS or email, as described above.

FIG. 6 illustrates an example of utilizing hybrid information for transaction-initiated Offer Communications, in accordance with an embodiment. In this example, the process begins with the payer purchasing a ticket for the theater. As the transaction is processed in a typical fashion, simultaneously another process determines whether another reward or offer is available based on the transaction in process.

Using the rules database and inclusion tables contained in the network operator, appropriate programs, offers, and limitations are determined. If non-transactional information is not to be utilized, the transaction simply proceeds in a normal fashion. However, if non-transactional information is to be utilized, the network operator preferably determines three parameters for searching for an offer: payer location is determined using proximity system (mobile device); Rewards and loyalty system, and any other appropriate non-transactional database systems are searched for offers; and payer preferences, which have been pre-set by the payer, are queried to determine the nature of rewards preferred (e.g., cash back, points, discounts, restaurant, merchandise, shopping etc.)

If there are in fact available offers within the boundaries and limitations of the prior steps, an SMS or other message is sent to the payer's mobile device with information on the reward being provided. If there are no offers available, the transaction proceeds in a normal fashion and the process ends.

The payer then has the information needed to utilize the reward or offer on a separate transaction and the process ends.

Through system 100, methods 300 and 400, and the examples above, the use of multiple data flows, both transactional and non-transactional, in real time to modify a transaction has been demonstrated. Further the use of transaction information in real time as a decision factor to trigger a different, non-transactional response has been demonstrated.

These two approaches can be used separately, or in conjunction with one another, to significantly change and improve the real-time use of data flows extracted from both current POS/POP transaction data content and outside data sources, with the intent to better assess transactions, make improved real-time decisions, and deliver increased value to the network operator and to the customer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for processing an electronic payment transaction in real-time on an electronic financial transaction processing network, the payment transaction having been initiated by a payer with a merchant, the method comprising:
receiving, through the electronic transaction processing network, an authorization request from a merchant to authorize a transaction to be funded with a first amount of funds from a financial account, the financial account associated with the payer and held by an issuing facility;
determining, from the request, information identifying the payer and the issuing facility;
electronically querying one or more data sources using the identifying information for the payer;
receiving, in response to the query, additional payer information;
computing a modification for the authorization request using the additional payer information; and
transmitting the modified authorization request to the issuing facility.

2. The method of claim 1 further comprising the step of notifying the payer of the modification in response to receiving the indicator of approval of the modified authorization request from the issuing facility.

3. The method of claim 2 wherein the notifying comprises transmitting an SMS, e-mail or multimedia message to the payer.

4. The method of claim 1 wherein the financial account is a type from the group consisting of: credit accounts; debit accounts; pre-paid accounts; and alternative payment accounts.

5. The method of claim 1 wherein the data source is external to the financial transaction processing network, and wherein the electronic querying comprises transmitting an electronic query over an electronic communications channel with the data source.

6. The method of claim 1 wherein the data source is a proximity system for determining the location of the payer and/or the merchant and/or nearby merchants.

7. The method of claim 1 wherein the data source is a payer service system for determining a payer satisfaction level or past payer activity based on a history of service.

8. The method of claim 1 wherein the data source is a weather information system for determining the weather conditions in the proximity of the payer.

9. The method of claim 1 wherein the data source comprises one or more rewards and loyalty systems.

9. The method of claim 1 wherein the wherein the modification comprises a reduction in the amount requested for authorization.

10. The method of claim 1 wherein the modification comprises changing an indicator in a field of the authorization request to indicate that certain criteria have been met.

11. The method of claim 1 further comprising: upon receiving an indicator of approval of the modified authorization request from the issuing facility, transmitting an approval notification message to the merchant through the electronic transaction processing network.

12. A system for processing an electronic payment transaction from a payer to a merchant in real-time on an electronic financial transaction processing network comprising:
a first network interface for receiving an authorization request for the payment transaction from the merchant over the transaction processing network;
a plurality of electronically accessible data providing systems;
a data storage device for storing one or more filtering rules;
a filtering engine in connection with the data storage device and the first network interface for applying the filtering rules to the transaction;
a querying engine for querying one or more of the plurality of data providing systems with queries according to the filtered transaction;
a transaction modification engine for modifying the authorization request according to one or more responses to the queries;
a second network interface for sending the modified authorization request to an issuing facility holding a financial account of the payer, and for receiving a response to the modified authorization request from the facility; and
a notification system for notifying the payer of the modification.

13. The system of claim 12 wherein at least one of the plurality of data providing systems is located at a different geographic location from the first network interface.

14. A method for processing an electronic payment transaction in real-time on an electronic financial transaction processing network, the payment transaction having been initiated by a payer with a merchant, the method comprising:
receiving, through the electronic transaction processing network, an authorization request from a merchant to authorize a transaction to be funded with a first amount of funds from a financial account, the financial account associated with the payer and held by an issuing facility;
determining, from the request, information identifying the payer and the issuing facility;
electronically querying one or more data sources using the identifying information for the payer;
receiving, in response to the query, additional payer information;
generating an offer for the payer using the additional payer information;
transmitting the authorization request to the issuing facility; and
upon receiving an indicator of approval of the authorization request from the issuing facility, transmitting the generated offer to the payer over a secondary channel.

15. The method of claim 14 wherein the external data source is a proximity system for determining the location of the payer.

16. The method of claim 14 wherein the external data source is a payer service system for determining the payer's history of service.

17. The method of claim 14 wherein the external data source is a weather information system for determining the weather conditions in the proximity of the payer.

18. The method of claim 14 wherein the external data source comprises one or more rewards and loyalty systems.

19. The method of claim 14 wherein the secondary channel is SMS or electronic mail.

20. The method of claim 14 wherein the transmitted offer comprises a promotional code for use at a second merchant.

21. The method of claim 20 wherein the second merchant is located in the general proximity of the payer.

22. The method of claim 20 wherein the transmitted offer is redeemable only at a physical presence of the second merchant.

23. A method of receiving a discount during a transaction with a merchant, the method comprising:
providing the merchant with a number for charging the transaction through a first device controlled by the merchant, the account number associated with a financial account held by an issuing facility;
if a response is received via the first device that the transaction has been approved, receiving on a secondary device, in response to the approved transaction, a promotional offer.

24. The method of claim 23 wherein the promotional offer is received via a personal electronic device of the payer.

25. The method of claim 23 wherein the promotional offer is for use at a second merchant in the geographic vicinity of the payer.

26. The method of claim 23 wherein the promotional offer is for use at a second merchant through an online interface.

27. The method of claim 23 wherein the promotional offer is received via SMS or electronic mail.

28. A method for generating promotional offers to a plurality of payers for a plurality of merchants, the method comprising:
receiving a first authorization request from a terminal device co-located with a first merchant to authorize a transaction to be funded with funds from a first financial account, the first financial account associated with a first payer and held by a first issuing facility;
receiving a second authorization request from a terminal device co-located with a second merchant to authorize a transaction to be funded with funds from a second financial account, the second financial account associated with a second payer and held by a second issuing facility;
determining, from the requests, information identifying the first payer and the first merchant;
determining, from the requests, information identifying the second payer and the second merchant;
maintaining in an electronic database:
a first record comprising the number of times the first payer has transacted with the first merchant and the total value of those transactions; and
a second record comprising the number of times the second payer has transacted with the second merchant and the total value of those transactions;
updating the first record with information from the first transaction;
updating the second record with information from the second transaction;
determining, from the database, whether the first payer has met a first threshold value associated with the first merchant;
determining, from the database, whether the second payer has met a second threshold value associated with the second merchant;
if the first payer has met the first threshold, generating an offer for the first payer and transmitting the generated offer to the first payer over a secondary channel; and
if the second payer has met the second threshold, generating an offer for the second payer and transmitting the generated offer to the second payer over a secondary channel.

29. The method of claim 28 wherein the first threshold or the second threshold represents an amount of money.

30. The method of claim 28 wherein the first threshold or the second threshold represents a frequency counter for tracking the number of times a payer has interacted with the first or second merchant.
